(19) United States
(12) Patent Application Publication
(10) Pub. No.: US 2023/0323909 A1
(43) Pub. Date: Oct. 12, 2023

(54) FASTENER STRUCTURE

(71) Applicant: TING-JUI WANG, New Taipei City (TW)

(72) Inventor: TING-JUI WANG, New Taipei City (TW)

(21) Appl. No.: 18/336,046

(22) Filed: Jun. 16, 2023

Related U.S. Application Data
(63) Continuation of application No. 16/843,905, filed on Apr. 9, 2020.

(51) Int. Cl. F16B 21/09

(52) U.S. Cl. CPC F16B 21/09

(57) ABSTRACT

A fastener structure includes a body and a fastening portion. The fastening portion is provided on one end of the body, and includes a neck configured to be receivingly fastened into, assembled into or fitted with a coupling counterpart. Thus, the handle and the coupling counterpart may be assembled during use, and the handle may be removed from the coupling counterpart when not in use, achieving effects of easy operation and collision prevention. Further, the fastener structure may be assembled to a first object, and be fastening connected to a second object or removed from the second object so as to complete coupling or separation of at least two objects, achieving the effect of repeated quick coupling and separation.

### CROSS-REFERENCE TO RELATED APPLICATION

This application is a continuation application of U.S. application Ser. No. 16/843,905 filed on Apr. 9, 2020, the entire contents of which are hereby incorporated by reference for which priority is claimed under 35 U.S.C. § 120.

### BACKGROUND OF THE INVENTION

### 1. Field of the Invention

The present disclosure provides a fastener structure, and more particularly to a fastener structure that may be fastening connected or removed.

### 2. Description of the Related Art

To offer portability and transportation convenience of a common object, a handle is usually provided on the object (for example, a suitcase, a box, a door . . . etc.) for a user to easily apply a force for purposes of portability and transportation. However, in the conventional handle above, two ends of the handle are locked, connected and fixed on outer sides of the object by using screws and cannot be collapsed after having been provided, such that the handle constantly protrudes from the surface of the object, causing interference in the arrangement of the object (because the protruding handle does not allow the object to be leaned close to a wall surface) as well as collisions when not in use. Further, after use for a certain amount of time, the handle may even fall off due to loosening of the screws and can no longer be used.

Further, when coupling at least two objects, lock connection is usually performed using a screw so as to couple the objects. However, although being capable of coupling at least two objects into a form that is not easily separated, the conventional fixing means above can result, in addition to a complicated assembly process, that at least one of the objects may not be easily disassembled due to the fixed coupling means of the screws.

Therefore, the present disclosure aims to disclose an disclosure of a fastener structure that enables a handle and a coupling counterpart to be assembled during use and the handle to be removed from the coupling counterpart when not in use to achieve effects of easy operation and collision prevention, or enables completing of coupling or separation of at least two objects to achieve the effect of repeated quick coupling and separation.

### BRIEF SUMMARY OF THE INVENTION

In view of the issues and drawbacks of the prior art, the inventor has dedicated to research and development of a fastener structure, which enables a handle and a coupling counterpart to be assembled during use and the handle to be removed from the coupling counterpart when not in use to achieve effects of easy operation and collision prevention, or enables completing of coupling or separation of at least two objects to achieve the effect of repeated quick coupling and separation.

To achieve the above object and other objects, the present disclosure provides a fastener structure, and the fastener structure includes a body and a fastening portion. The fastening portion is provided on one end of the body, and includes a neck configured to be receivingly fastened into, assembled into or fitted with a coupling counterpart.

In the foregoing fastener structure, a fixing connection portion is provided on the other end of the body.

In the foregoing fastener structure, the fastening portion is configured to enter a receiving fastening portion of the coupling counterpart and to be receivingly fastened in a fitting fastening portion of the coupling counterpart by the neck.

In the foregoing fastener structure, once the neck is receivingly fastened in the fitting fastening portion, the neck is receiving fastened or locked in a fixing connection portion on the other end of the body by a coupling member so as to be assembled with the coupling counterpart.

In the foregoing fastener structure, a fastening portion is provided on each of both ends of the handle, the coupling counterpart includes two receiving fastening portions and two fitting fastening portions. The fastening portions are configured to first enter the receiving fastening portions of the coupling counterpart, and the necks are respectively receivingly fastened in the fitting fastening portions of the coupling counterpart so as to be fastening connected with the coupling counterpart.

In the foregoing fastener structure, the fastening portion is configured to enter a receiving fastening portion of the coupling counterpart, and the neck is receivingly fastened in an intermediate portion of the coupling counterpart and then fittingly fastened at a fitting fastening portion of the coupling counterpart by a fitted fastening portion of the fastening portion.

In the foregoing fastener structure, the fastening portion includes an abutting element. The abutting element is configured to be receivingly fastened in or to enter the fitting fastening portion, so as to abut against the body and the coupling counterpart or to abut the fastening portion and the coupling counterpart.

In the foregoing fastener structure, the neck includes a stopping portion, the stopping portion is provided in the body, and an abutting element is provided between the body and the stopping portion. Two ends of the abutting element are respectively abutted against the body and the stopping portion, so as to constantly locate the neck in a withdrawn position.

In the foregoing fastener structure, the neck may be pulled out from the withdrawn position by an external force so as to enter the fitting fastening portion and be fastening connected.

In the foregoing fastener structure, the neck includes a stopping portion, the stopping portion is provided in the body, and an abutting element is provided between the body and the stopping portion. Two ends of the abutting element are respectively abutted against the body and the stopping portion, so as to constantly locate the neck in a withdrawn position.

In the foregoing fastener structure, the neck may be pulled out from the withdrawn position by an external force so as to enter the intermediate portion and then be fastening connected at the fitting fastening portion by the fitted fastening portion.

In the foregoing fastener structure, the stopping portion is arranged on a base, which is assembled with the body.

In the foregoing fastener structure, the abutting element is an elastic piece, an elastic column, a spring or an elastic fastener.

In the foregoing fastener structure, the fastening portion includes a neck, the neck is a material storage space, and the body or the fastening portion is configured to be pressed by an external force such that the material of the coupling counterpart enters or flows into the material storage space so as to assemble the handle with the coupling counterpart.

In the foregoing fastener structure, the external force may be further pressed on a shoulder on the body.

In the foregoing fastener structure, the fastening portion is pressed by an external force to form a neck, which is a material retaining portion for retaining the coupling counterpart so as to be assembled with the coupling counterpart.

In the foregoing fastener structure, the fastening portion is a neck, and the body or the neck has a welding surface configured to be welded to a corresponding portion of the coupling counterpart.

In the foregoing fastener structure, the body or the fastening portion is configured to be welded by solder to the corresponding portion of the coupling counterpart, and the corresponding portion is a corresponding opening, groove, plane, recess or protrusion.

In the foregoing fastener structure, the handle is picked up by a tool and placed at the coupling counterpart so as to perform assembly.

In the foregoing fastener structure, the handle is picked up by a tool and placed at an assembly position of the coupling counterpart, or is picked up by a tool and compared with an assembly position of the coupling counterpart by a comparison device, so as to be accurately placed on the assembly position of the coupling counterpart.

In the foregoing fastener structure, the handle is configured to be placed on a carrier, which includes or does not include a cover.

In the foregoing fastener structure, the body includes a base, which is assembled or connected to the fastening portion or the neck.

In the foregoing fastener structure, the base is assembled with the body, movably assembled with the body, or assembled with the body by a coupler.

In the foregoing fastener structure, the body includes a material extrusion portion for extruding the material of the coupling counterpart into the neck.

In the foregoing fastener structure, the handle includes an anti-slip portion for providing an anti-slip effect.

In the foregoing fastener structure, the fitting fastening portion is a protrusion, a recess or a blocking structure configured to interfere with or block the body, the fastening portion or the handle.

In the foregoing fastener structure, the intermediate portion is a protrusion, a recess or a blocking structure configured to interfere with or block the body, the fastening portion, the fitted fastening portion or the handle.

In the foregoing fastener structure, the neck includes an operating portion extending on an outer side of the handle and configured to control movement of the fastening portion.

In the foregoing fastener structure, the handle includes two fastening portions. One of the fastening portions is configured to enter a receiving fastening portion of the coupling counterpart, enter an intermediate portion of the coupling counterpart and then be receivingly fastened in a fitting fastening portion of the coupling counterpart. The other fastening portion is configured to enter a receiving fastening portion of the coupling counterpart, and then be receivingly fastened in a fitting fastening portion of the coupling counterpart.

In the foregoing fastener structure, the handle includes two fastening portions. The fastening portions are configured to enter a receiving fastening portion of the coupling counterpart, enter an intermediate portion of the coupling counterpart, and then be receivingly fastened in a fitting fastening portion of the coupling counterpart.

In the foregoing fastener structure, the handle includes a fastening portion and a fixing connection portion. The fastening portion is configured to enter a receiving fastening portion of the coupling counterpart, enter an intermediate portion of the coupling counterpart, and then be receivingly fastened in a fitting fastening portion of the coupling counterpart. The fixing connection portion is configured to be fixed at the coupling counterpart.

In the foregoing fastener structure, the handle includes at least one coupling portion configured to enable the fastening portion to be receivingly fastened into at least one fitting fastening portion of the coupling counterpart, and the coupling portion is receivingly fastened into at least one securing portion of the coupling counterpart so as to limit the horizontal movement, vertical movement or rotational movement of the fastening portion. Alternatively, the coupling portion is configured to abut against or interference with the surface of the coupling counterpart so as to limit the horizontal movement, vertical movement or rotational movement of the fastening portion.

In the foregoing fastener structure, the handle includes at least one coupling portion. The fastening portion is first receivingly fastened in at least one fitting fastening portion of the coupling counterpart, and the coupling portion is then receivingly fastened in at least one securing portion of the coupling counterpart so as to limit the horizontal movement, vertical movement or rotational movement of the fastening portion. Alternatively, the coupling portion is configured to abut against or interference with the surface of the coupling counterpart so as to limit the horizontal movement, vertical movement or rotational movement of the fastening portion.

In the foregoing fastener structure, the coupling portion is an elastic fastener having an elastic fastening arm.

In the foregoing fastener structure, the securing portion is in communication with the fitting fastening portion, or the securing portion is not in communication with the fitting fastening portion.

In the foregoing fastener structure, the width of the fastening portion is less than that of the receiving fastening portion, and the width of the fitting fastening portion is more than that of the neck and less than that of the fastening portion.

In the foregoing fastener structure, the width of the fastening portion is less than that of the receiving fastening portion, and the width of the fitting fastening portion or the intermediate portion is more than that of the neck or the fitted fastening portion and less than that of the fastening portion.

In the foregoing fastener structure, the body or the fastening portion includes an interference portion configured to interfere with or block the coupling counterpart.

In the foregoing fastener structure, the abutting element may be a formed integral with the handle.

In the foregoing fastener structure, the abutting element and the handle are mutually connected by a connecting portion in between.

In the foregoing fastener structure, the fixing connection portion may be a formed integral with the handle, the fixing connection portion is bolt connected to the handle, the fixing connection portion is rivet connected, fastening connected, expansion connected, welding connected, lock connected, fittingly connected or hot-melt connected to the handle, or the fixing connection portion and the handle are assembled by in-mold injection.

In the foregoing fastener structure, an anti-rotation portion is provided on the surface of the fixing connection portion, and is configured to prevent the fixing connection portion assembled on the body from departing or rotating.

In the foregoing fastener structure, the body or the fastening portion is configured to be placed in a conductive fluid, and an antirust material is attached to the head or the body by the conductive fluid.

In the foregoing fastener structure, the body, the fastening portion, the conductive fluid or the antirust material is current conductive, so as to move and attach the antirust material to the head or the body.

The present disclosure further provides a fastener structure. The fastener includes a fastening portion and a blocking portion. The fastener passes through an elongated hole of a first object by the blocking portion, and is receivingly fastened in a receiving fastening portion of the first object by the fastening portion, such that the blocking portion limits movement of the fastener. An outer diameter of the fastening portion is less than that of the receiving fastening portion, and an outer diameter of the blocking portion is more than that of the receiving fastening portion.

In the foregoing fastener structure, the fastener includes a body, which is movably assembled with a head or another fastening portion.

In the foregoing fastener structure, the head or the another fastening portion and the body are elastically resisted by an elastic element.

In the foregoing fastener structure, the fastener includes a body, which is a handle.

In the foregoing fastener structure, the body is a handle including a fastening portion on each of both ends thereof, or the body is a handle including a fastening portion on one side thereof.

In the foregoing fastener structure, a stopper is further included. The stopper is configured to be installed or blocked at the elongated hole or the receiving fastening portion, so as to stop at the elongated hole or the receiving fastening portion to prevent the fastening portion from departing from the elongated hole or the receiving fastening portion.

In the foregoing fastener structure, the stopper includes an obstructing portion. The obstructing portion is larger than the elongated hole or the receiving fastening portion, and is configured to fittingly fasten or fittingly connect at the elongated hole, the receiving fastening portion, or any part of the object.

In the foregoing fastener structure, the stopper includes a body, which is larger than, equal to or smaller than the elongated hole or the receiving fastening portion.

In the foregoing fastener structure, the blocking portion may pass through the first object and a second object, and be receivingly fastened in the receiving fastening portion of the first object and be receivingly fastened in the second object.

In the foregoing fastener structure, the another fastening portion is a feed trough, and the material of a second object enters or flows into the feed trough when the fastener presses the second object.

In the foregoing fastener structure, the another fastening portion is an expansion connection portion configured to be fittingly connected to a second object when pressed by an external force.

In the foregoing fastener structure, the another fastening portion is a welding portion configured to be welded to a second object.

In the foregoing fastener structure, the stopper includes a connecting portion configured to be connected and assembled with the fastener or to become a formed integral with the fastener.

In the foregoing fastener structure, a stopper is further included. The stopper is configured to be installed or blocked at the elongated hole or the receiving fastening portion after the fastening portion is first receivingly fastened in the receiving fastening portion, so as to stop at the elongated hole or the receiving fastening portion to prevent the fastening portion from departing from the elongated hole or the receiving fastening portion.

In the foregoing fastener structure, the elongated hole or the receiving fastening portion between the blocking portion or the fastening portion and the stopper includes a floating space, which is configured to allow the fastening portion or the blocking portion to move in the floating space.

In the foregoing fastener structure, the floating space is a movement track of the fastener.

In the foregoing fastener structure, the elongated hole or the receiving fastening portion produces a deformed portion when the elongated hole or the receiving fastening portion is pressed by an external force, so as to provide a stopping effect at the elongated hole or the receiving fastening portion to prevent the fastening portion from departing from the elongated hole or the receiving fastening portion.

In the foregoing fastener structure, the fastening portion is first receivingly fastened in the receiving fastening portion, and an external force is applied on the elongated hole or the receiving fastening portion to produce a deformed portion at the elongated hole or the receiving fastening portion, so as to provide a stopping effect at the elongated hole or the receiving fastening portion to prevent the fastening portion from departing from the elongated hole or the receiving fastening portion.

In the foregoing fastener structure, between the deformed portion and one of the blocking portions or the fastening portion is a floating space, which is configured to allow the fastening portion or the blocking portion to move in the floating space.

In the foregoing fastener structure, the floating space is a movement track of the fastener.

In the foregoing fastener structure, the fastener includes two blocking portions configured to limit the first object between the two blocking portions.

In the foregoing fastener structure, a stopper is further included. The stopper is configured to block movement of the fastener, such that the fastener is limited at the first object and cannot be departed.

In the foregoing fastener structure, the fastening portion is surrounded by or assembled with an abutting element. The abutting element is configured to block the receiving fastening portion of the object, or to block a fitting fastening portion of the object.

In the foregoing fastener structure, the abutting element includes a guiding portion, which is configured to guide the abutting element for fastening connection or blocking.

In the foregoing fastener structure, the abutting element includes a step portion, which may be receivingly fastened in the fitting fastening portion or the receiving fastening portion.

In the foregoing fastener structure, the width of the step portion is more than or less than that of the receiving fastening portion, or the width of the step portion is less than that of the fitting fastening portion so as to fittingly fix the abutting element.

In the foregoing fastener structure, an elastic element is further included. One end of the elastic element is abutted against the abutting element, and the other end is abutted against the blocking portion.

In the foregoing fastener structure, the body is bolt assembled with the fastening portion by a coupler.

In the foregoing fastener structure, a stopper is further included. The stopper may be stopped at the elongated hole or the fastening portion to prevent the fastening portion from departing from the elongated hole or the receiving fastening portion.

The present disclosure further provides a fastener structure. The fastener structure includes an elongated hole and a receiving fastening portion. The fastener passes through a blocking portion of a first object by the elongated hole, and is receivingly fastened with a fastening portion of the first object by the receiving fastening portion, so as to limit movement of the fastener by the blocking portion.

Thus, the fastener structure of the present disclosure may be used to assemble a handle with a coupling counterpart when in use and to remove the handle from the coupling counterpart when not in use, achieving effects of easy operation and collision prevention. Further, the fastener structure may be assembled to a first object, and be fastening connected to a second object or removed from the second object so as to complete coupling or separation of at least two objects, achieving the effect of repeated quick coupling and separation.

### BRIEF DESCRIPTION OF THE DRAWINGS

FIG. 1 is a schematic diagram of a cross section state according to a first embodiment of the present disclosure.

FIG. 2 is a first schematic diagram of an assembly state according to the first embodiment of the present disclosure.

FIG. 3 is a second schematic diagram of an assembly state according to the first embodiment of the present disclosure.

FIG. 4 is a third schematic diagram of an assembly state according to the first embodiment of the present disclosure.

FIG. 5 is a schematic diagram of a cross section state according to a second embodiment of the present disclosure.

FIG. 6 is a schematic diagram of an assembly state according to the second embodiment of the present disclosure.

FIG. 7 is a first schematic diagram of an assembly state according to a third embodiment of the present disclosure.

FIG. 8 is a second schematic diagram of an assembly state according to the third embodiment of the present disclosure.

FIG. 9 is a schematic diagram of a structure according to a fourth embodiment of the present disclosure.

FIG. 10 is a schematic diagram of an assembly state according to the fourth embodiment of the present disclosure.

FIG. 11 is a schematic diagram of a structure according to a fifth embodiment of the present disclosure.

FIG. 12 is a schematic diagram of an assembly state according to the fifth embodiment of the present disclosure.

FIG. 13 is a schematic diagram of an assembly state according to a sixth embodiment of the present disclosure.

FIG. 14 is a schematic diagram of an assembly state according to a seventh embodiment of the present disclosure.

FIG. 15 is a schematic diagram of an assembly state according to an eighth embodiment of the present disclosure.

FIG. 16 is a schematic diagram of an assembly state according to a ninth embodiment of the present disclosure.

FIG. 17 is a schematic diagram of an assembly state according to a tenth embodiment of the present disclosure.

FIG. 18 is a schematic diagram of an assembly state according to an eleventh embodiment of the present disclosure.

FIG. 19 is a schematic diagram of an assembly state according to a twelfth embodiment of the present disclosure.

FIG. 20 is a schematic diagram of an assembly state according to a thirteenth embodiment of the present disclosure.

FIG. 21 is a schematic diagram of an assembly state according to the thirteenth embodiment of the present disclosure.

FIG. 22 is a schematic diagram of an assembly state according to the thirteenth embodiment of the present disclosure.

FIG. 23 is a schematic diagram of an assembly state according to a fourteenth embodiment of the present disclosure.

FIG. 24 is a schematic diagram of a fastening connected state after assembly according to the fourteenth embodiment of the present disclosure.

FIG. 25 is a schematic diagram of an assembly state according to a fifteenth embodiment of the present disclosure.

FIG. 26 is a schematic diagram of an assembly state according to a sixteenth embodiment of the present disclosure.

FIG. 27 is a schematic diagram of an appearance according to a seventeenth embodiment of the present disclosure.

FIG. 28 is a schematic diagram of different forms of a fixing connection portion of the present disclosure.

FIG. 29 is a schematic diagram of an appearance according to an eighteenth embodiment of the present disclosure.

FIG. 30 is a schematic diagram of an appearance according to a nineteenth embodiment of the present disclosure.

FIG. 31 is a schematic diagram of an appearance according to a twentieth embodiment of the present disclosure.

FIG. 32 is a schematic diagram of a state of use according to the twentieth embodiment of the present disclosure.

FIG. 33 is a schematic diagram of a cross section state according to a twenty-first embodiment of the present disclosure.

FIG. 34 is a schematic diagram of a cross section state according to a twenty-second embodiment of the present disclosure.

FIG. 35 is a schematic diagram of a cross section state according to a twenty-third embodiment of the present disclosure.

FIG. 36 is a schematic diagram of a cross section state according to a twenty-fourth embodiment of the present disclosure.

FIG. 37 is a schematic diagram of a state of appearance according to a twenty-fifth embodiment of the present disclosure.

FIG. 38 is a first schematic diagram of a state of use according to the twenty-fifth embodiment of the present disclosure.

FIG. 39 is a second schematic diagram of a state of use according to the twenty-fifth embodiment of the present disclosure.

FIG. 40 is a schematic diagram of a state of appearance according to a twenty-sixth embodiment of the present disclosure.

FIG. 41 is a first schematic diagram of a state of use according to the twenty-sixth embodiment of the present disclosure.

FIG. 42 is a second schematic diagram of a state of use according to the twenty-sixth embodiment of the present disclosure.

FIG. 43 is a first schematic diagram of a state of use according to a twenty-seventh embodiment of the present disclosure.

FIG. 44 is a second schematic diagram of a state of use according to the twenty-seventh embodiment of the present disclosure.

FIG. 45 is a third schematic diagram of a state of use according to the twenty-seventh embodiment of the present disclosure.

FIG. 46 is a schematic diagram of different forms of another fastening portion of the present disclosure.

FIG. 47 is a schematic diagram of different forms of a stopper of the present disclosure.

FIG. 48 is a schematic diagram of an assembly state according to a twenty-eighth embodiment of the present disclosure.

FIG. 49 is a schematic diagram of an assembly state according to a twenty-ninth embodiment of the present disclosure.

FIG. 50 is a schematic diagram of an assembly state according to a thirtieth embodiment of the present disclosure.

FIG. 51 is a schematic diagram of an assembly state according to a thirty-first embodiment of the present disclosure.

FIG. 52 is a schematic diagram of a state of use according to a thirty-second embodiment of the present disclosure.

FIG. 53 is a schematic diagram of a state of use according to a thirty-third embodiment of the present disclosure.

FIG. 54 is a schematic diagram of a state of use according to a thirty-fourth embodiment of the present disclosure.

FIG. 55 is a schematic diagram of a state of use according to a thirty-fifth embodiment of the present disclosure.

FIG. 56 is a schematic diagram of a first object and a second object according to a thirty-sixth embodiment of the present disclosure.

FIG. 57 is a schematic diagram of a state of use according to a thirty-seventh embodiment of the present disclosure.

FIG. 58 is a schematic diagram of a state of use according to a thirty-eighth embodiment of the present disclosure.

FIG. 59 is a schematic diagram of a state of use according to a thirty-ninth embodiment of the present disclosure.

### DETAILED DESCRIPTION OF THE INVENTION

To fully understand the objects, features and functions of the present disclosure, details of the present disclosure are given in specific embodiments with the accompanying drawings below.

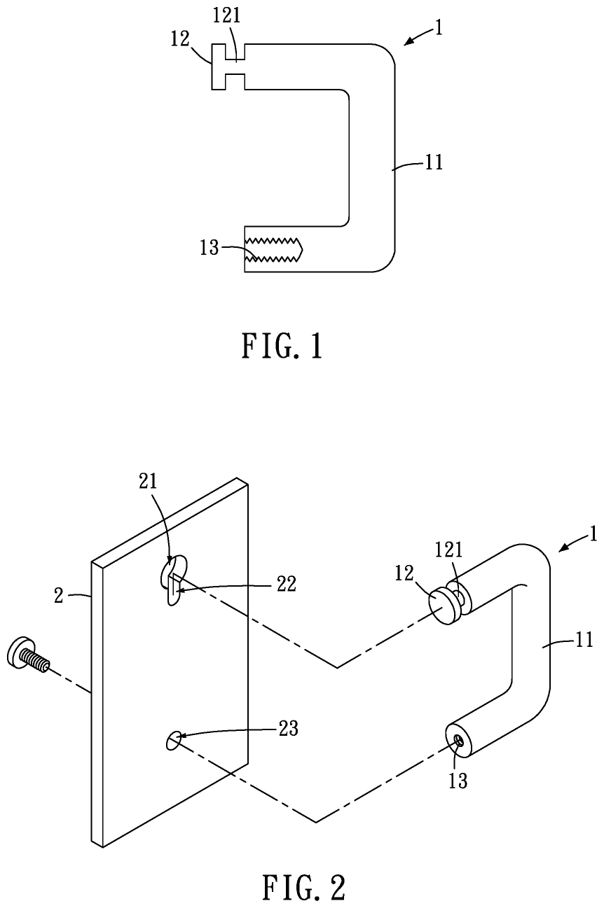

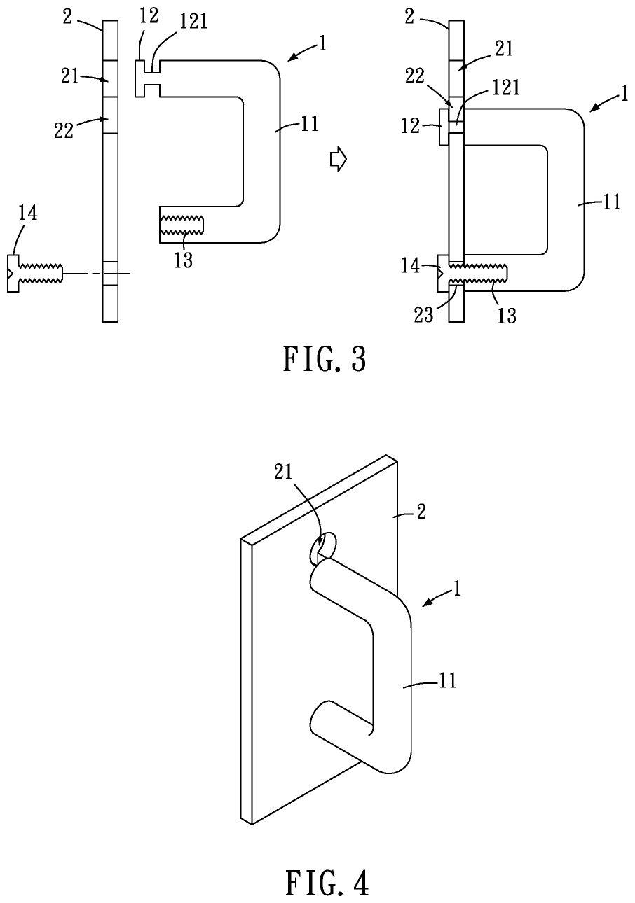

Refer to FIG. 1 to FIG. 4. As shown, the present disclosure provides a fastener structure, and the fastener structure 1 includes a body 11 and a fastening portion 12.

The fastening portion 12 is provided on one end of the body 11, and includes a neck 121 configured to be receivingly fastened into, assembled into, or fitted with a coupling counterpart 2.

When in use, the handle 1 may be assembled with the coupling counterpart 2 by the fastening portion 12; when not in use, the fastening portion 12 of the handle 1 is removed from the coupling counterpart 2, achieving effects of easy operation and collision prevention.

In a preferred specific embodiment of the present disclosure, a fixing connection portion 13 is provided on the other end of the body 11. The coupling counterpart 2 includes a receiving fastening portion 21 and a fitting fastening portion 22 that are in communication with each other. Once the handle 1 enters the receiving fastening portion 21 of the coupling counterpart 2 by the fastening portion 12, the neck 121 is receivingly fastened in the fitting fastening portion 22 of the coupling counterpart 2. Once the neck 121 is receivingly fastened in the fitting fastening portion 22, the fixing connection portion 13 corresponds to a corresponding portion 23 of the coupling counterpart 2, and a coupling member 14 is receivingly fastened or locked in the fixing connection portion 13 on the other end of the body 11, so as to assemble the handle 1 with the coupling counterpart 2 for further use. To remove the handle 1, the coupling member 14 may be removed from the fixing connection portion 13, the neck 121 is moved from the fitting fastening portion 22 to the receiving fastening portion 21, and the fastening portion 12 is then removed from the coupling counterpart 2, so as to separate the handle 1 from the coupling counterpart 2. Thus, the handle 1 and the coupling counterpart 2 may be assembled during use, and the handle 1 may be removed from the coupling counterpart 2 when not in use, achieving effects of easy operation and collision prevention.

In a preferred specific embodiment of the present disclosure, the coupling counterpart 2 may be a housing, a plate, a box, a circuit board, a plate, a metal body or a plastic body. Thus, the present disclosure is enabled to better meet requirements of actual applications.

In a preferred specific embodiment of the present disclosure, the fitting fastening portion 22 may be a protrusion, a recess or a blocking structure, and is configured to interfere with or block the body 11, the fastening portion 12 or the handle 1. Thus, the present disclosure is enabled to better meet requirements of actual applications.

In a preferred specific embodiment of the present disclosure, the fixing connection portion 13 may be a screw locking portion, a fastening portion, an elastic fastening portion, a hook fastening portion, a nut portion or a screw portion. Thus, the present disclosure is enabled to better meet requirements of actual applications.

In a preferred specific embodiment of the present disclosure, the fixing connection portion 13 is a formed integral with the handle 1, the fixing connection portion 13 is bolt connected to the handle 1, the fixing connection portion 12 is rivet connected, fastening connected, expansion connected, welding connected, lock connected, fittingly connected or hot-melt connected to the handle 1, or the fixing connection portion 13 and the handle 1 are assembled by in-mold injection.

In a preferred specific embodiment of the present disclosure, the handle 1 and the components thereof may be formed by turning, forging, injection, in-mold injection, stamping, bending, mutual movable assembly or assembly. Thus, the present disclosure is enabled to better meet requirements of actual applications.

In a preferred specific embodiment of the present disclosure, the handle 1 and the components thereof may be in a metal material, a non-metal material or a plastic material. Thus, the present disclosure is enabled to better meet requirements of actual applications.

In a preferred specific embodiment of the present disclosure, the body 11, the fastening portion 12 or the neck 121 of the handle 1 is formed by plastic in-mold injection. Thus, the present disclosure is enabled to better meet requirements of actual applications.

In a preferred specific embodiment of the present disclosure, the width of the fastening portion 12 is less than that of the receiving fastening portion 21, and the width of the fitting fastening portion 22 is more than that of the neck 121 and less than that of the fastening portion 12. Thus, once the fastening portion 12 enters the receiving fastening portion 21 of the coupling counterpart 2, the neck 121 is receivingly fastened in the fitting fastening portion 22 of the coupling counterpart 2, thereby enabling the handle 1 and the coupling counterpart 2 to achieve a stable coupling effect.

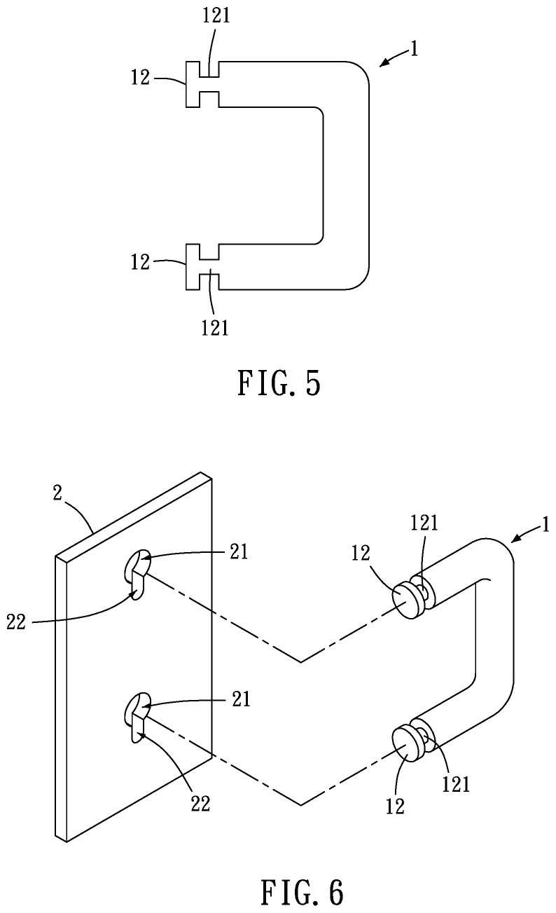

Referring to FIG. 5 and FIG. 6, as shown, in a preferred specific embodiment of the present disclosure, a fastening portion 12 is provided on each of both ends of the handle 1, and the coupling counterpart 2 includes two receiving fastening portions 21 and two fitting fastening portions 22. The fastening portions 12 first respectively enter the receiving fastening portions 21 of the coupling counterpart 2, and are respectively receivingly fastened in the fitting fastening portions 22 of the coupling counterpart 2 by the necks 121, so as to fastening connect the handle 1 with the coupling counterpart 2 for further use. When not in use, the necks 121 are respectively moved from the fitting fastening portions 22 to the receiving fastening portions 21 to further remove the fastening portions 12 from the coupling counterpart 2, so as to separate the handle 1 from the coupling counterpart 2. Thus, the handle 1 may be assembled with the coupling counterpart 2 when in use, and the handle 1 may be removed from the coupling counterpart 2 when not in use, achieving effects of easy operation and collision prevention.

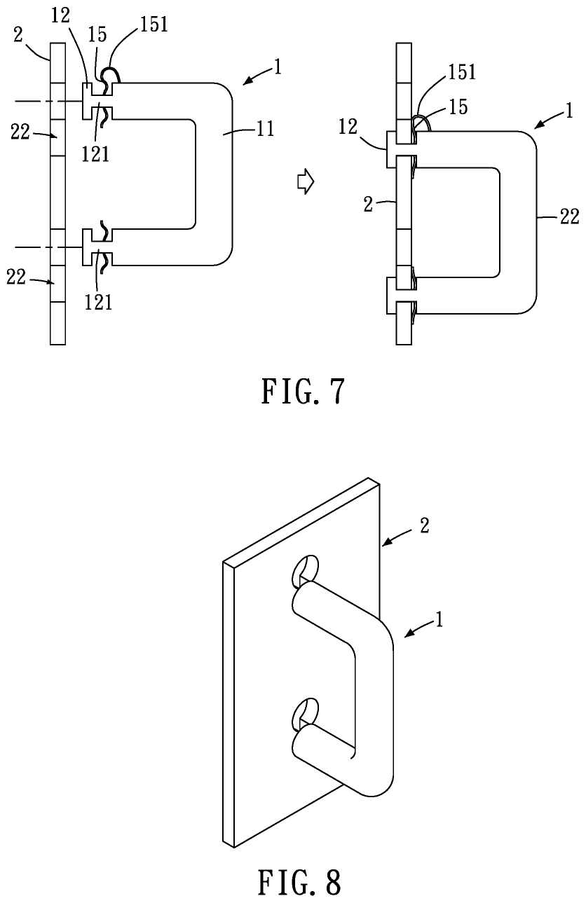

Referring to FIG. 7 and FIG. 8, as shown, in a preferred specific embodiment of the present disclosure, the fastening portion 12 includes an abutting element 15.

The abutting element 15 surrounds the neck 121, and is configured to be receivingly fastened with the fitting fastening portion 22 of the coupling counterpart 2 and to abut against the body 11 and the coupling counterpart 2. In this embodiment, the fastening portion 12 and the abutting element 15 are two in quantity, and may also be provided as one in quantity according to requirements of actual applications. Thus, the handle 1 and the coupling counterpart 2 are enabled to achieve an effect of stable coupling using the abutting element 15.

In a preferred specific embodiment of the present disclosure, the abutting element 15 may be an elastic piece, an elastic column, a spring or an elastic fastener, and the abutting element 15 and the handle 1 may be a formed integral (not shown). Thus, the present disclosure is enabled to better meet requirements of actual applications.

In a preferred specific embodiment of the present disclosure, the abutting element 15 and the handle 1 may be connected to each other by a connecting portion 151 in between. Thus, the present disclosure is enabled to better meet requirements of actual applications.

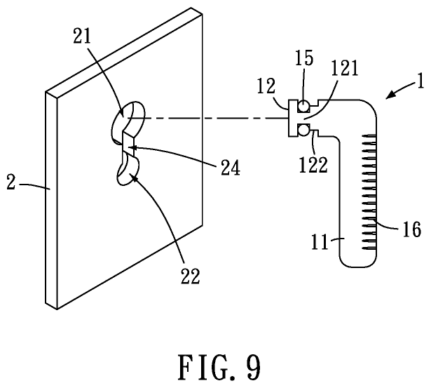

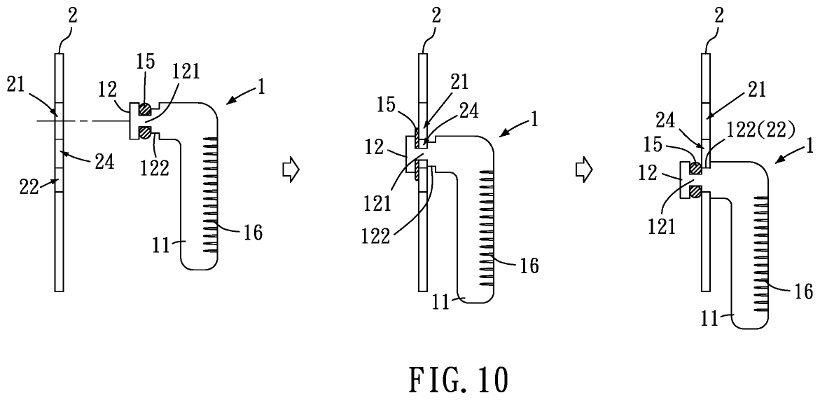

Referring to FIG. 9 and FIG. 10, as shown, in a preferred specific embodiment of the present disclosure, the fastening portion includes an abutting element 15, and includes a fitted fastening portion 122. The coupling counterpart 2 includes a receiving fastening portion 21, a fitting fastening portion 22 and an intermediate portion 24 that are in communication, wherein the intermediate portion 24 is provided between the receiving fastening portion 21 and the fitting fastening portion 22. The fastening portion 12 is configured to enter the receiving fastening portion 21, the neck 121 is receivingly fastened in the intermediate portion 24, the fitted fastening portion 122 of the fastening portion 12 is fittingly fastened in the fitting fastening portion 22, and the abutting element 15 is receivingly fastened or enters the fitting fastening portion 22 so as to abut against the fastening portion 12 and the coupling counterpart 2. Thus, the handle 1 and the coupling counterpart 2 are enabled to achieve an effect of stable coupling using the abutting element 15.

In a preferred specific embodiment of the present disclosure, the handle includes an anti-slip portion 16 for providing an anti-slip effect. The anti-slip portion 16 may be a protrusion, a recess, an anti-slip body, a plane, a toothed portion, a step portion, an arc surface, a curved surface or an inclined surface. Thus, the present disclosure is enabled to better meet requirements of actual applications.

In a preferred specific embodiment of the present disclosure, the intermediate portion 24 may be a protrusion, a recess or a blocking structure, and is configured to interfere with or block the body 11, the fastening portion 12, the fitted fastening portion 122 or the handle 1. Thus, the present disclosure is enabled to better meet requirements of actual applications.

In a preferred specific embodiment of the present disclosure, the width of the fastening portion 12 is less than that of the receiving fastening portion 21, and the width of the fitting fastening portion 22 or the intermediate portion 24 is more than that of the neck 121 or the fitted fastening portion 122 and less than that of the fastening portion 12. Thus, the fastening portion 12 is allowed to enter the receiving fastening portion 21, the neck 121 is receivingly fastened in the intermediate portion 24, and the fitted fastening portion 122 of the fastening portion 12 is fittingly fastened in the fitting fastening portion 22, enabling the handle 1 and the coupling counterpart 2 to achieve an effect of stable coupling.

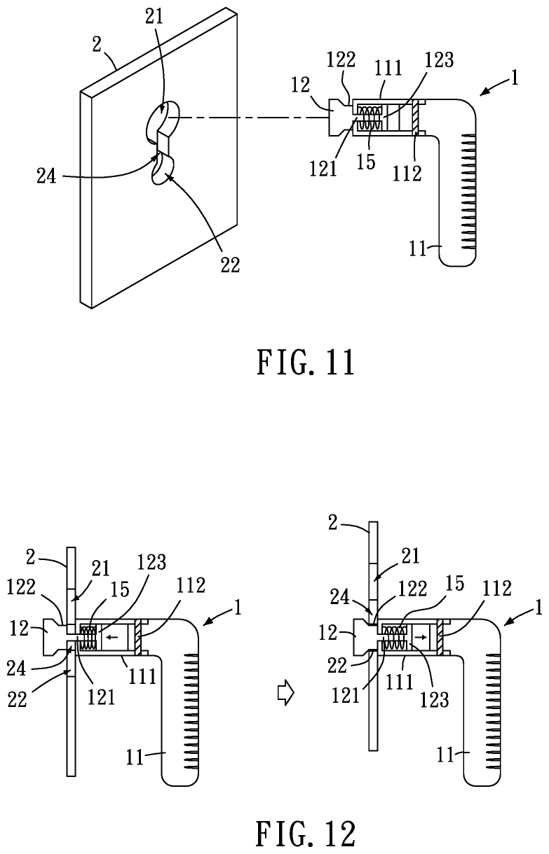

Referring to FIG. 11 and FIG. 12, as shown, in a preferred specific embodiment of the present disclosure, the neck includes a stopping portion 123, which is provided in the body 11. An abutting element 15 is provided between the body 11 and the stopping portion 123, two ends of the abutting element 15 are respectively abutted against the body 11 and the stopping portion 123, and the abutting element 15 is configured to constantly locate the neck 121 in a withdrawn position. When in use, the neck 121 is pulled out from the withdrawn position by an external force, so as to enter the intermediate portion 24 and be fastening connected to the fitting fastening portion 22 by the fitted fastening portion 122. Thus, the handle 1 and the coupling counterpart 2 are enabled to achieve an effect of stable coupling.

In a preferred specific embodiment of the present disclosure, the body 11 includes a base 111, the base 111 is assembled or connected to the fastening portion 12 and the neck 121, and the stopping portion 123 is placed in the base 111. The base 111 is assembled or movably assembled with the body 11, or is assembled with the body 11 by a coupler 112. In this embodiment, the base 111 and the body 11 are assembled by a coupler 112, so as to enable the base 111 and the body 11 to achieve an effect of stable coupling.

In a preferred specific embodiment of the present disclosure, the coupler 112 may be a rod, a fastener, a rivet or a pin. Thus, the present disclosure is enabled to better meet requirements of actual applications.

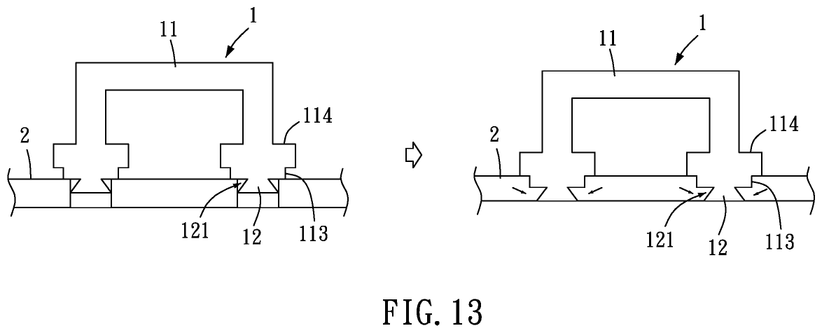

Referring to FIG. 13, as shown, in a preferred specific embodiment of the present disclosure, the fastening portion 12 includes a neck 121, which is a material storage space, and the body 11 includes a material extrusion portion 113. The body 11 or the fastening portion 12 is pressed by an external force, such that the material of the coupling counterpart 2 enters or flows into the material storage space and the material extrusion portion 113, so as to assemble the handle 1 with the coupling counterpart 2.

In a preferred specific embodiment of the present disclosure, the external force may further press upon a shoulder 114 of the body 11, hence achieving an effect of easy application of force.

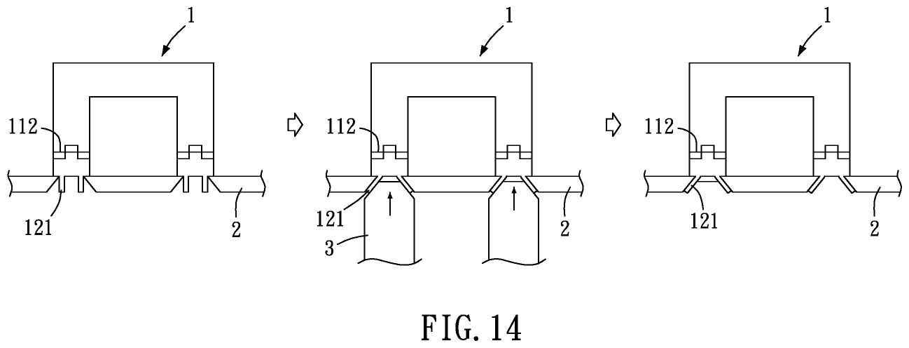

Referring to FIG. 14, as shown, in a preferred specific embodiment of the present disclosure, the fastening portion 12 is pressed by an external force of a tool 3 to form a neck 121. The neck 121 is a material retaining portion configured to retain the coupling counterpart 2 and to assemble the handle 1 with the coupling counterpart 2.

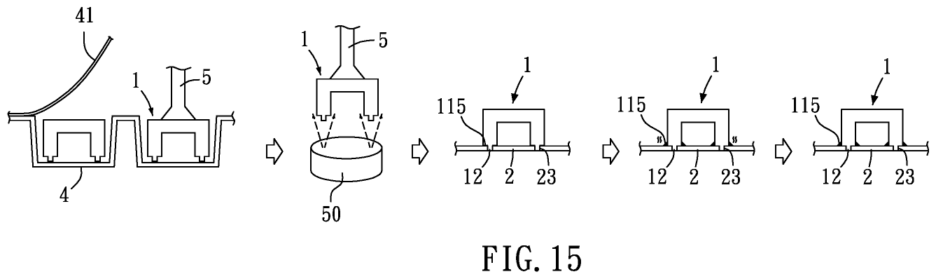

Referring to FIG. 15, as shown, in a preferred specific embodiment of the present disclosure, the handle 1 is placed on a carrier 4, which includes a cover 41 or does not include a cover 41. Further, once the handle 1 is picked up by a tool 5, an assembly position of the coupling counterpart 2 is compared by a comparison device 50, so as to accurately place the handle 1 on the assembly position of the coupling counterpart 2 and to assemble the handle 1 with the coupling counterpart 2.

In a preferred specific embodiment of the present disclosure, the fastening portion 12 is a neck, and the body 11 or the neck 12 has a welding surface 115 configured to be welded to a corresponding portion 23 of the coupling counterpart 2, so as to stably assemble the handle 1 with the coupling counterpart 2.

In a preferred specific embodiment of the present disclosure, the body 11 or the fastening portion 12 is configured to be welded to the corresponding portion 23 of the coupling counterpart 2 by solder (that is, the welding surface 115), wherein the corresponding portion 23 is a corresponding opening, groove, plane, recess or protrusion. Thus, the present disclosure is enabled to better meet requirements of actual applications.

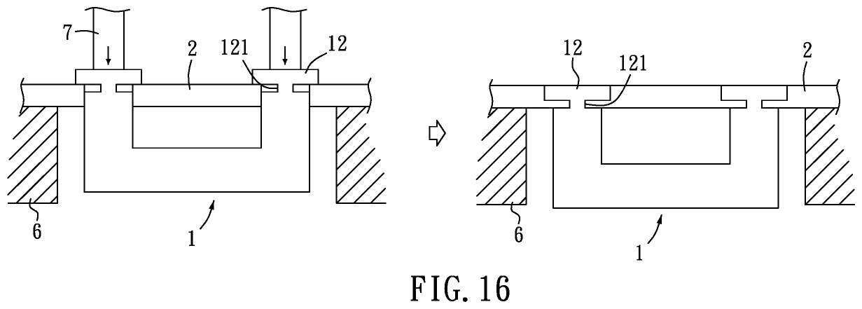

Referring to FIG. 16, as shown, in a preferred specific embodiment of the present disclosure, the fastening portion 12 includes a neck 121, which is a material storage space. The coupling counterpart 2 may be provided at a support mold 6, and the fastening portion 12 (or the body 11) is pressed by a downward pressing mold 7, such that the material of the coupling counterpart 2 enters or flows into the material storage space (that is, the neck 121), so as to assemble the handle 1 with the coupling counterpart 2.

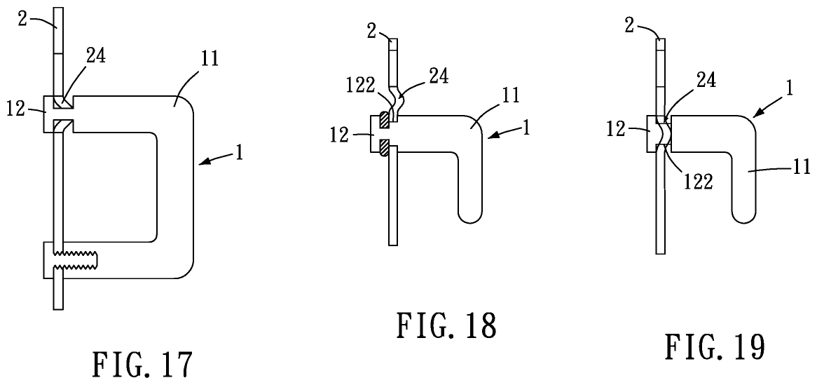

Referring to FIG. 17 to FIG. 19, as shown, in a preferred specific embodiment of the present disclosure, the intermediate portion 24 of the coupling counterpart 2 is a blocking structure configured to interfere with or block the body 11, the fastening portion 12, the fitted fastening portion 122 or the handle 1. Thus, the present disclosure is enabled to better meet requirements of actual applications.

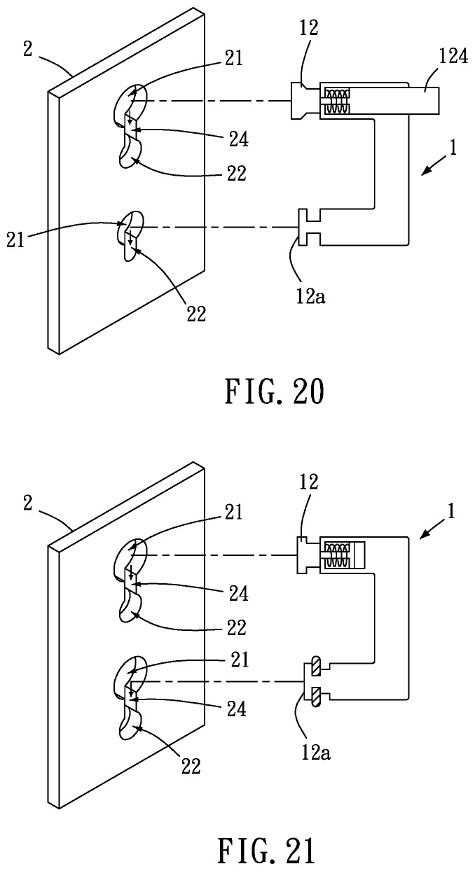

Referring to FIG. 20, as shown, in a preferred specific embodiment of the present disclosure, the handle 1 includes two fastening portions 12 and 12a, and the neck 121 of one of the fastening portions 12 includes an operating portion 124 extending on an outer side of the handle and configured to control movement of the fastening portion 12. For assembly, one of the fastening portions 12 is configured to enter a receiving fastening portion 21 of the coupling counterpart 2, enter an intermediate portion 24 of the coupling counterpart 2, and be receivingly fastened in a fitting fastening portion 22 of the coupling counterpart 2; the other fastening portion 12a is configured to enter a receiving fastening portion 21 of the coupling counterpart 2 and is then receivingly fitted into a fitting fastening portion 22 of the coupling counterpart 2, so as to enable the handle 1 and the coupling counterpart 2 to achieve an effect of stable assembly.

Referring to FIG. 21, as shown, in a preferred specific embodiment of the present disclosure, the handle 1 includes two fastening portions 12 and 12a. The fastening portions 12 and 12a are configured to enter a receiving fastening portion 21 of the coupling counterpart 2, enter an intermediate portion 24 of the coupling counterpart 2, and be receivingly fastened in a fitting fastening portion 22 of the coupling counterpart 2, so as to enable the handle 1 and the coupling counterpart 2 to achieve an effect of stable assembly.

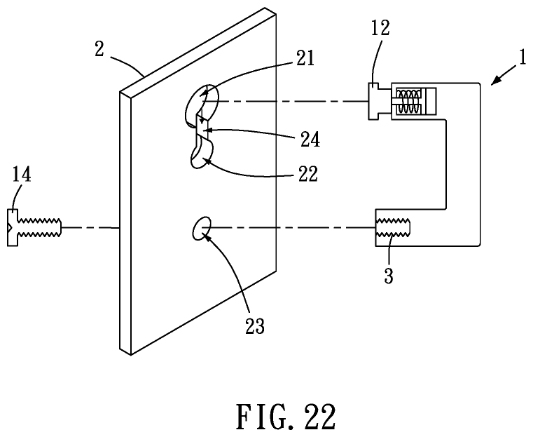

Referring to FIG. 22, as shown, in a preferred specific embodiment of the present disclosure, the handle 1 includes a fastening portion 12 and a fixing connection portion 13. The fastening portion 12 is configured to enter a receiving fastening portion 21 of the coupling counterpart 2, enter an intermediate portion 24 of the coupling counterpart 2, and be receivingly fastened in a fitting fastening portion 22 of the coupling counterpart 2. The fixing connection portion 13 is configured to first correspond to a corresponding portion 23 of the coupling counterpart, and then be matchingly fixedly at the coupling counterpart 2 by a coupling member 14, so as to enable the handle 1 and the coupling counterpart 2 to achieve an effect of stable assembly.

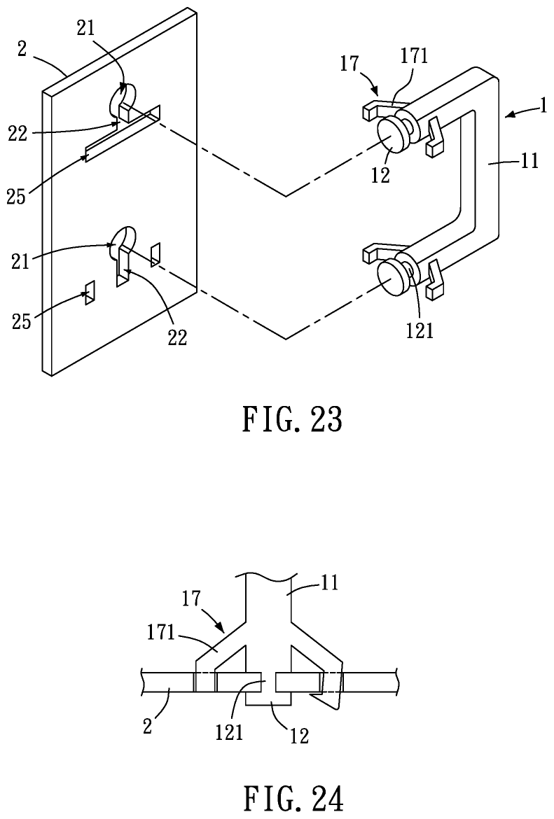

Referring to FIG. 23 and FIG. 24, as shown, in a preferred specific embodiment of the present disclosure, the handle 1 includes at least one coupling portion 17. To assemble the handle 1 with the coupling counterpart 2, the fastening portion 12 is first receivingly fastened in at least one fitting fastening portion 21 of the coupling counterpart 2, and is then receivingly fastened in at least one securing portion 25 of the coupling counterpart 2 by the coupling portion 17, so as to limit horizontal movement, vertical movement or rotational movement of the fastening portion 12 (or the coupling portion 17 is configured to abut against or interfere with the surface of the coupling counterpart 2 so as to limit horizontal movement, vertical movement or rotational movement of the fastening portion 12). Thus, the handle 1 and the coupling counterpart 2 are enabled to achieve an effect of stable assembly.

In a preferred specific embodiment of the present disclosure, the coupling portion 17 is four in quantity, every two coupling portions 17 are provided on each of both sides of a fastening portion 12, and the securing portion 25 is in a quantity corresponding to the quantity of the coupling portions 17. Thus, the handle 1 and the coupling counterpart 2 are enabled to achieve an effect of stable assembly.

In a preferred embodiment of the present disclosure, the coupling portion 17 is an elastic fastener having an elastic fastening arm 171. Thus, the coupling portion 17 is enabled to be tightly fastened at the securing portion 25 by the elastic fastening arm 171, so as to enable the handle 1 and the coupling counterpart 2 to achieve an effect of stable assembly.

In a preferred embodiment of the present disclosure, the securing portion 25 is in communication with the fitting fastening portion 22, or the securing portion 25 is not in communication with the fitting fastening portion 22. Thus, the present disclosure is enabled to better meet requirements of actual applications.

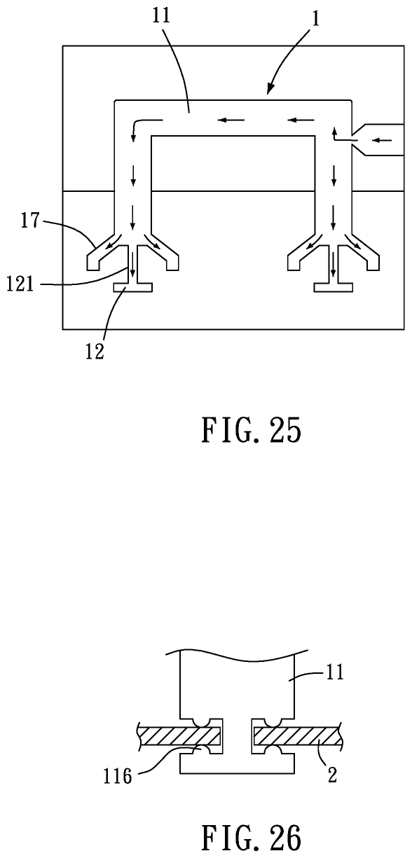

Referring to FIG. 25, as shown, in a preferred embodiment of the present disclosure, the body 11, the fastening portion 12, the blocking portion 12a, the neck 121 or the coupling portion 17 of the handle 1 is formed by plastic in-mold injection. Thus, the present disclosure is enabled to better meet requirements of actual applications.

Referring to FIG. 26, as shown, in a preferred specific embodiment of the present disclosure, the body 11 (or the fastening portion 12) includes an interference portion 116 configured to interfere with or block the coupling counterpart 2. Thus, the handle 1 and the coupling counterpart 2 are enabled to achieve an effect of stable assembly.

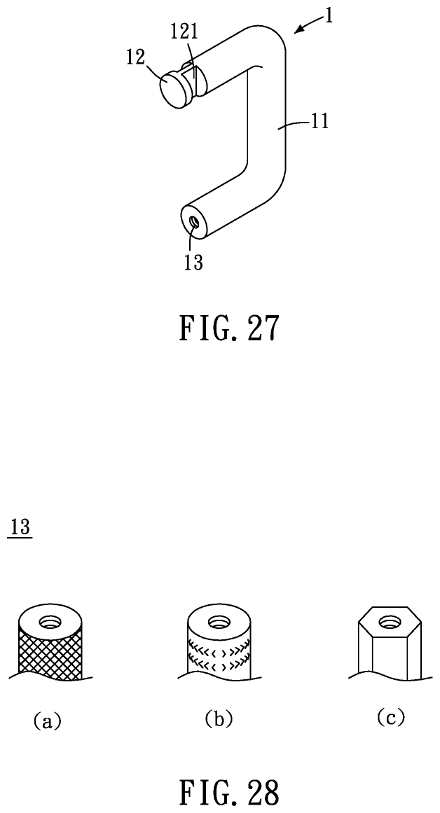

Referring to FIG. 27, as shown, in a preferred specific embodiment of the present disclosure, the fastening portion 12 is provided on one end of the body 11, and includes a flat neck 121 configured to be receivingly fastened into, assembled into or fitted with a coupling counterpart. The neck 121 may be single-grooved or dual-grooved, or a column smaller than the body or the fastening portion. Thus, the present disclosure is enabled to better meet requirements of actual applications.

Referring to FIG. 28, as shown, in a preferred specific embodiment of the present disclosure, an anti-rotation portion 131 is provided on the surface of the fixing connection portion 13, and is configured to prevent the fixing connection portion 13 assembled at the body 11 from departing or rotating. The anti-rotation portion 131 is an embossed pattern (as part a in FIG. 28), a toothed pattern (as part b in FIG. 28), a polygon (as part c in FIG. 28), a protrusion, a recess, a plane, an arc surface, a curved surface, a section portion, a slot or a hole. Thus, the present disclosure is enabled to better meet requirements of actual applications.

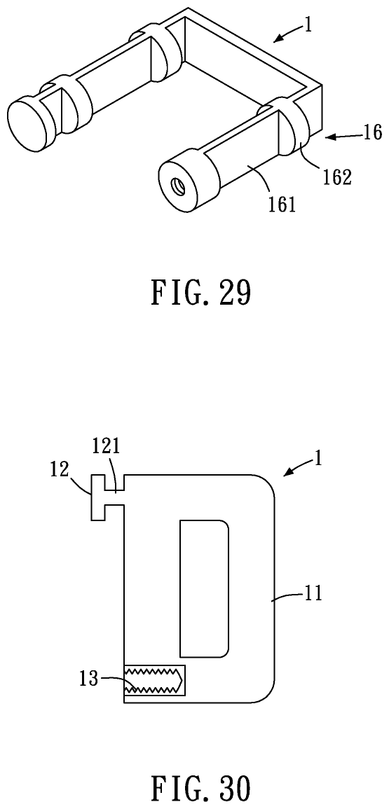

Referring to FIG. 29, as shown, in a preferred specific embodiment of the present disclosure, the anti-slip portion 16 is a recess 161 or a protrusion 162, and is configured to avoid shrinkage or recess of the surface caused during the manufacturing process of plastic in-mold injection of the handle 1. Thus, the present disclosure is enabled to better meet requirements of actual applications.

In a preferred specific embodiment of the present disclosure, the body 11 or the fastening portion 12 includes an electroplated layer, which may be a zinc-plated layer, a nickel-plated layer, a tin-plated layer, a chromium-plated layer, an anode layer or a copper-plated layer. For manufacturing, the body 11 or the fastening portion 12 may be placed in a conductive fluid, and the electroplated layer substance becomes attached to the body 11 or the fastening portion 12 using the conductive fluid 8. The body 11, the fastening portion 12, the conductive fluid or the electroplated layer substance is current conductive, such that the electroplated layer substance can be moved and attached to the body 11 or the fastening portion 12. Thus, the electroplated layer may serve as protection for the body 11 or the fastening portion 12 to prolong the durability of the body 11 or the fastening portion 12.

Further, the body 11 or the fastening portion 12 is made of a metal material, a non-metal material or a plastic material. The body 11 or the fastening portion 12 has a paint layer, a plastic color sleeve or a plastic layer (not shown) that serves as protection for the body 11 or the fastening portion 12 and prolongs the durability of the body 11 or the fastening portion 12, thereby responding to requirements of different utilization conditions.

In a preferred specific embodiment of the present disclosure, the body 11 or the fastening portion 12 has an antirust surface. During manufacturing, the body 11 or the fastening portion 12 may be placed in a conductive fluid, the antirust substance becomes attached to the body 11 or the fastening portion 12 using the conductive fluid, and the body 11, the fastening portion 12, the conductive fluid 8 and the antirust substance are electric current conductive, such that the electroplated layer substance 80a can be moved and attached to the body 11 or the fastening portion 12. Thus, the electroplated layer may serve as protection for the body 11 or the fastening portion 12 to prolong the durability of the body 11 or the fastening portion 12.

Referring to FIG. 30, as shown, in a preferred specific embodiment of the present disclosure, the body 11 of the handle 1 may be a loop, and the fastening portion 12 and the fixing connection portion are provided on one side of the body 11. Thus, the present disclosure is enabled to better meet requirements of actual applications.

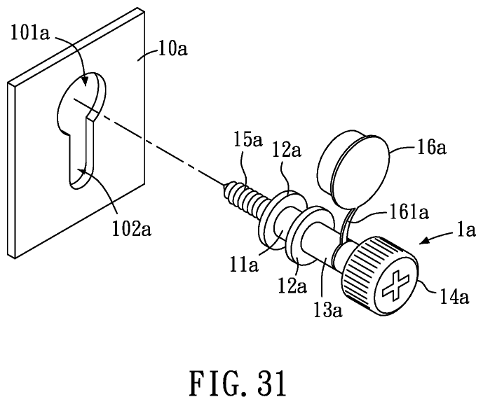

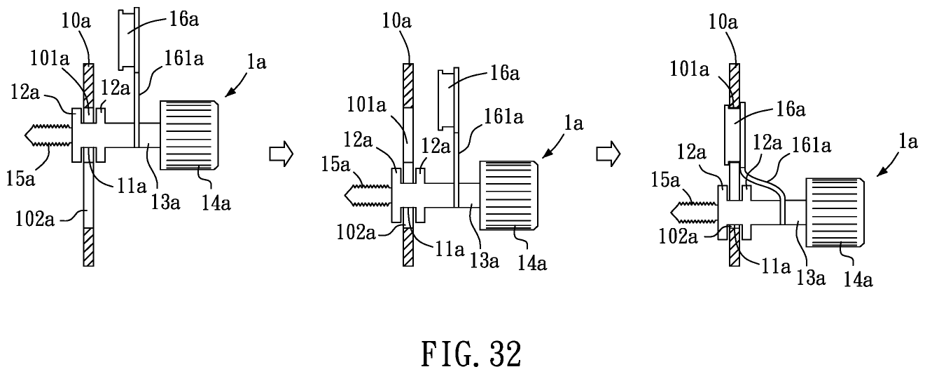

Referring to FIG. 31 and FIG. 32, as shown, the present disclosure provides a fastener structure. The fastener structure 1a includes a fastening portion 11a and two blocking portions 12a, and is configured to be receivingly fastened into a first object 10a. The first object 10a includes an elongated hole 101a and a receiving fastening portion 102a in communication with each other. For assembly, the fastener 101a passes through the elongated hole 101a by one of the blocking portions 12a, and is then receivingly fastened in the receiving fastening portion 102a by the fastening portion 11a, such that the two blocking portions 12a limit movement of the fastener 1a. Further, the outer diameter of the fastening portion 11a is less than that of the receiving fastening portion 102a, and the outer diameter of the blocking portions 12a is more than that of the receiving fastening portion 102a. Thus, the fastener 1a may be assembled to the first object 10a, and the fastener 1a may be fastening connected to a second object or be removed from the second object (not shown), so as to complete coupling or separation of at least two objects, achieving the effect of repeated quick coupling and separation.

In a preferred specific embodiment of the present disclosure, the fastener 1a includes a body 13a, which is movably assembled with a head 14a and another fastening portion 15a. Thus, once the fastener 1a is assembled with the first object 10a, the head 14a may be driven to fastening connect the another fastening portion 15a to the second object or be removed from the second object (not shown), so as to complete coupling or separation of at least two objects, achieving the effect of repeated quick coupling and separation.

In a preferred specific embodiment of the present disclosure, the another fastening portion 15a may be a thread body, a protruding fastener, a recessed fastener, an I-shaped body or a column. Thus, the another fastener 15a is enabled to better meet requirements for combining with the second object.

In a preferred specific embodiment of the present disclosure, a stopper 16a is further included. The stopper 16a is configured to be installed (or block) at the elongated hole 101a (or the receiving fastening portion 102a), so as to stop at the elongated hole 101a (or the receiving fastening portion 102a) to prevent the fastening portion 11a from departing from the elongated hole 101a (or the receiving fastening portion 102a), thereby enabling the fastener 1a to be stably assembled with the first object 10a.

In a preferred specific embodiment of the present disclosure, the stopper 16a includes a connecting portion 161a, which is configured to be connected and assembled with the body 13a of the fastener 1a or to be a formed integral with the fastener 1a. Thus, the stopper 16a is prevented from becoming lost by using the connecting portion 161a.

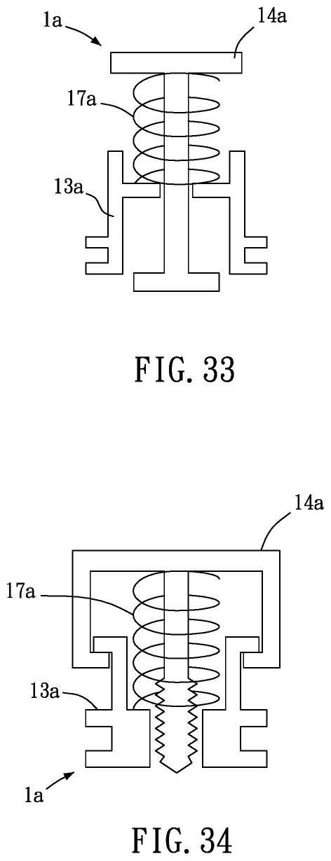

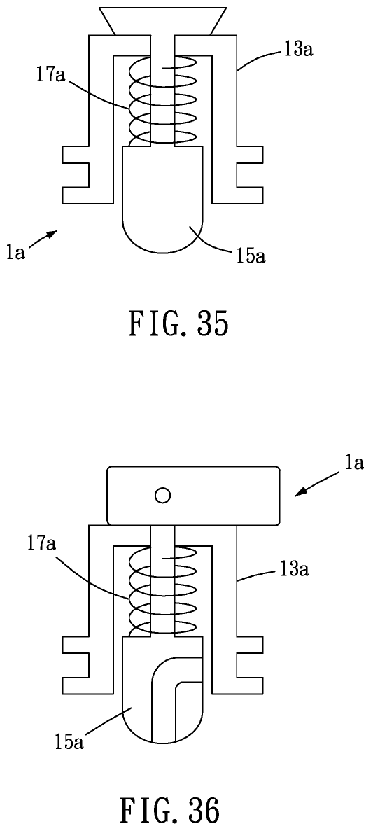

Referring to FIG. 33 to FIG. 36, as shown, in a preferred specific embodiment of the present disclosure, the head 14a and the body 13a are configured to be elastically resisted by an elastic element 17a (as shown in FIG. 33 and FIG. 34). Further, the another fastening portion 15a and the body 13a are elastically resisted by an elastic element 17a (as shown in FIG. 35 and FIG. 36). Thus, the fastener 1a is enabled to better meet requirements of actual applications.

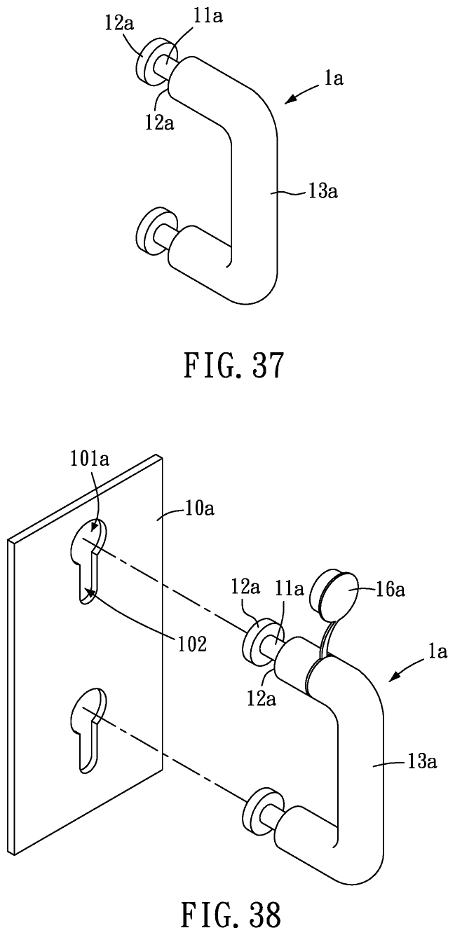

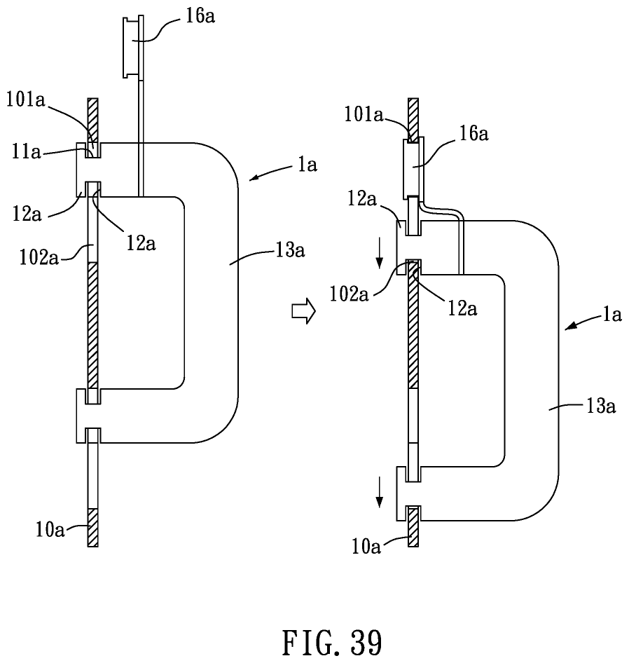

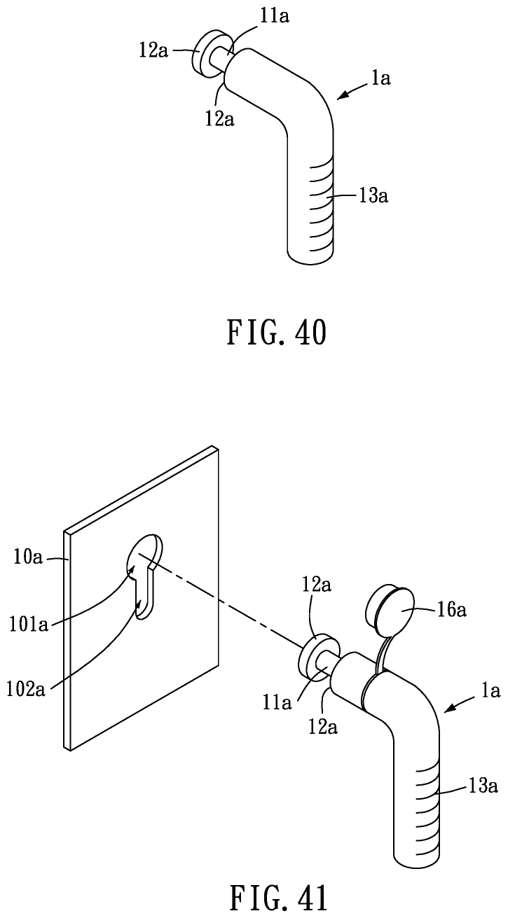

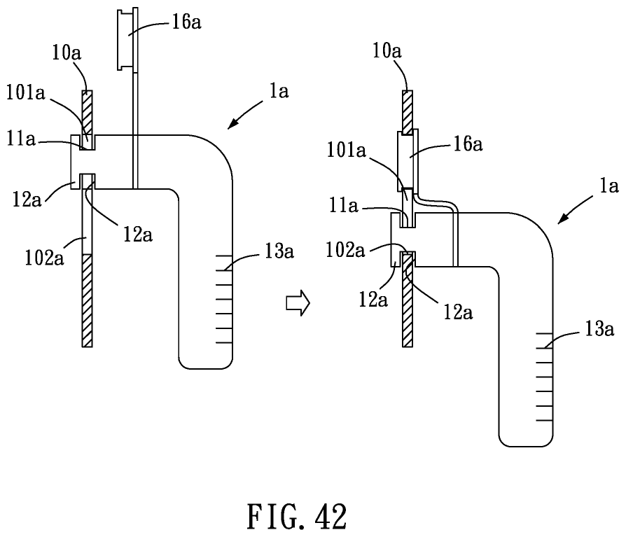

Referring to FIG. 37 to FIG. 42, as shown, in a preferred specific embodiment of the present disclosure, the fastener 1a includes a body 13a, which may be a handle having the fastening portion 11a on each of both sides thereof (as shown in FIG. 36 to FIG. 38). Further, the body may also be a handle having the fastening portion 11a on one side thereof (as shown in FIG. 40 to FIG. 42). For assembly, the fastener 1a passes through the elongated hole 101a by one of the blocking portions 12a, and is receivingly fastened in the receiving fastening portion 102a by the fastening portion 11a to limit movement of the fastener 1a by the two blocking portions 12a, and the stopper 16a is then installed (or blocked) at the elongated hole 101a, so as to provide a stopping effect at the elongated hole 101a to prevent the fastening portion 11a from departing from the elongated hole 101a, thereby enabling the fastener 1a to be stably assembled at the first object 10a.

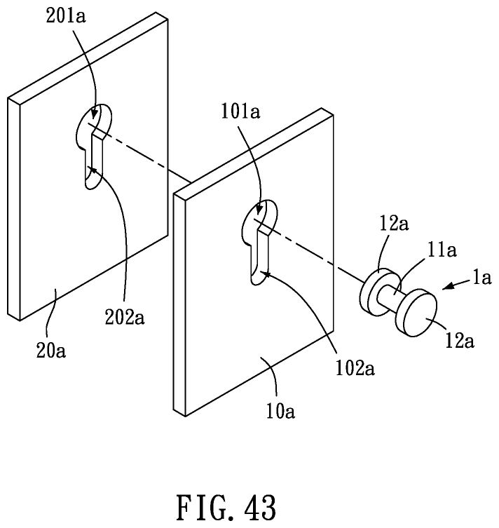

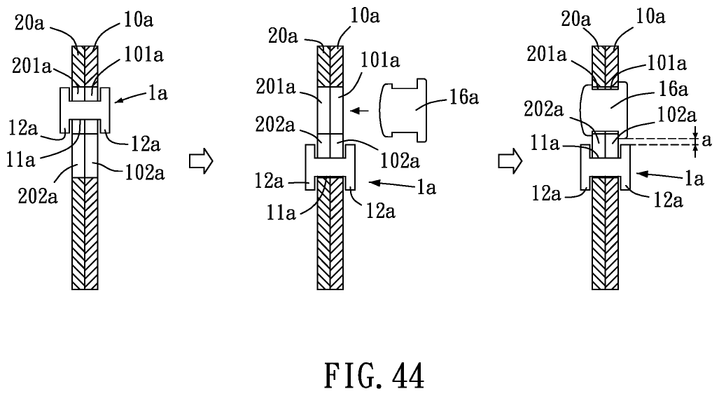

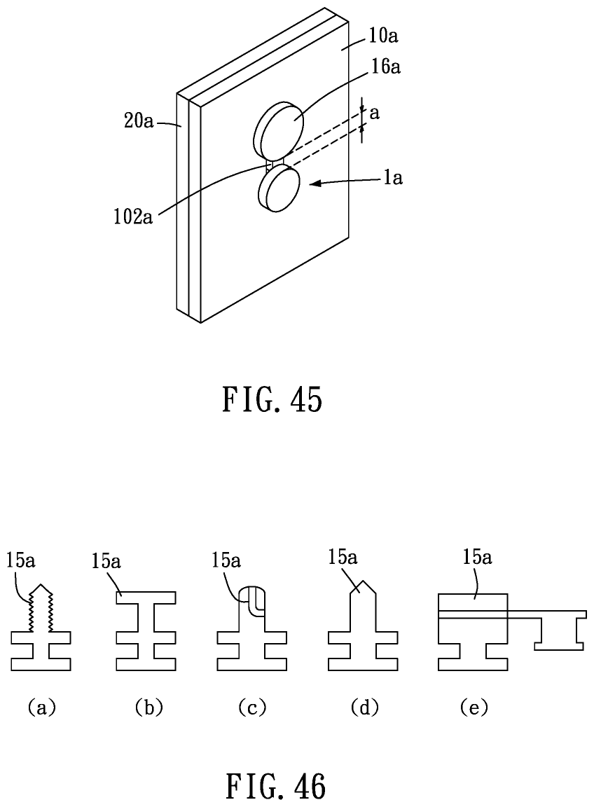

Referring to FIG. 43 to FIG. 45, as shown, in a preferred specific embodiment of the present disclosure, the blocking portion 12a of the fastener 1a may pass through the elongated hole 101a of the first object 10a and an elongated hole 201a of a second object 20a, and be receivingly fastened in the receiving fastening portion 101 of the first object 10a and a receiving fastening portion 202 of the second object 20a by the fastening portion 11a, and then the stopper 16a is installed (or blocked) at the elongated hole 101a so as to provide a stopping effect at the elongated hole 101a to prevent the fastening portion 11a from departing from the elongated hole 101a, thereby enabling the fastener 1a to be stably assembled with the first object 10a and the second object 20a.

In a preferred specific embodiment of the present disclosure, the elongated hole 101a or 201 (or the receiving fastening portion 102a or 202) between the blocking portion 12a (or the fastening portion 11a) and the stopper 16a includes a floating space a, which is configured to allow the fastening portion 11a (or the blocking portion 12a) to move therein. The floating space a has a dimension between 0.01 mm and 50000 mm, and is a movement track of the fastener 1a. Thus, the present disclosure is enabled to better meet requirements of actual applications.

Referring to FIG. 46, as shown, in a preferred specific embodiment of the present disclosure, the another fastening portion 15a may be a thread body (as part a in FIG. 46), a protruding fastener (as part b in FIG. 46), a recessed fastener (as part c in FIG. 46), a column (as part d in FIG. 46) or a head body (as part e in FIG. 46), an inner thread body, an outer thread body, a slot or a hole.

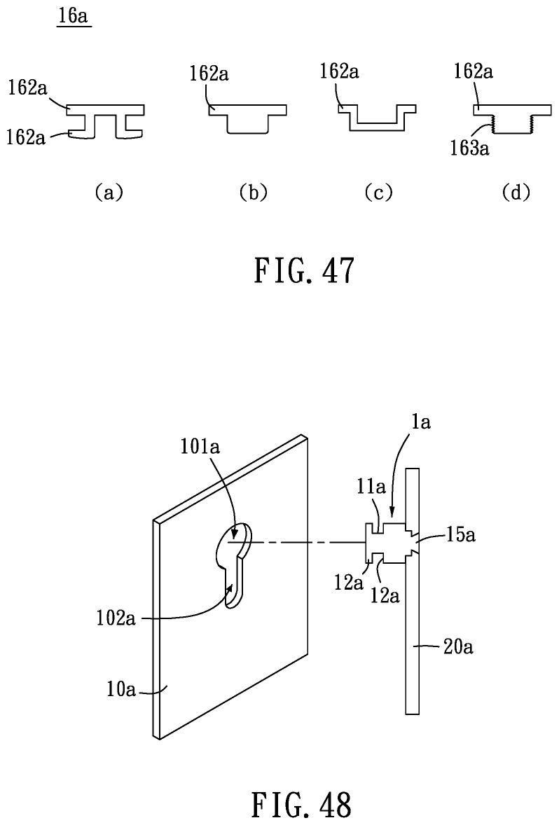

Referring to FIG. 47, as shown, in a preferred specific embodiment of the present disclosure, the stopper 16a may be a fastener (or an elastic fastener as part a in FIG. 47), a plug (as part b in FIG. 47), a plate (as part c in FIG. 47), a thread body (as part d in FIG. 47) or an elastic plate, and the stopper 16a may be made of a metal material, a non-metal material, a plastic material, a rubber material or a silicone material. Further, the stopper 16a includes an obstructing portion 162a (as parts a, b and d in FIG. 47). The obstructing portion 162a is larger than the elongated hole or the receiving fastening portion (not shown) of the first object, and is configured to fittingly fasten or fittingly connect at the elongated hole or the receiving fastening portion (or any part of the first object). Further, the stopper 16a includes a body 163 (as part d in FIG. 47), which is larger than, equal to or smaller than the elongated hole or the receiving fastening portion (not shown) of the first object. Thus, the stopper 16a is enabled to better meet requirements for coupling with the first object 10a.

Referring to FIG. 48, as shown, in a preferred specific embodiment of the present disclosure, the another fastening portion 15a is rivet connected, expansion connected, lock connected, welding connected or fastening connected to the second object 20a. The fastener 1a passes through the elongated hole 101a by one of the blocking portions 12a, and is then receivingly fastened in the receiving fastening portion 102a by the fastening portion 11a, so as to limit movement of the fastener 1a by the two blocking portions 12a, thereby enabling the fastener 1a to be stably assembled with the first object 10a.

In a preferred specific embodiment of the present disclosure, the another fastening portion 15a may be a feed trough, and is configured to allow the material of the second object 20a enter or flow into the another fastening portion 15a serving as the feed trough when the fastener 1a presses upon the second object 20a, thereby enabling the fastener 1a to be stably coupled with the second object 20a.

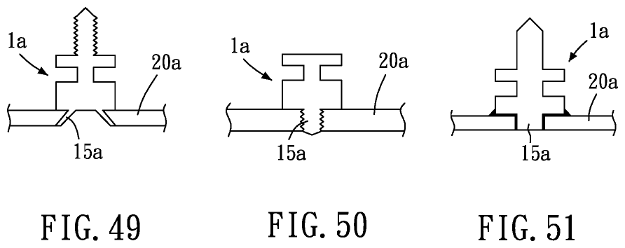

Referring to FIG. 49 to FIG. 51, as shown, in a preferred specific embodiment of the present disclosure, the another fastener 15a may be an expansion connection portion, and is configured to receive pressure of an external force applied thereon, such that the another fastening portion 15a is deformed and fittingly connected to the second object 20a (as shown in FIG. 49), thereby enabling the fastener 1a to be stably coupled to the second object 20a. Alternatively, the another fastening portion 15a may be a lock connection portion configured to be lock connected to the second object 20a (as shown in FIG. 50), thereby enabling the fastener 1a to be stably coupled to the second object 20a. Further, the another fastening portion may be a welding portion configured to be welded to the second object 20a (as shown in FIG. 51), thereby enabling the fastener 1a to be stably coupled to the second object 20a.

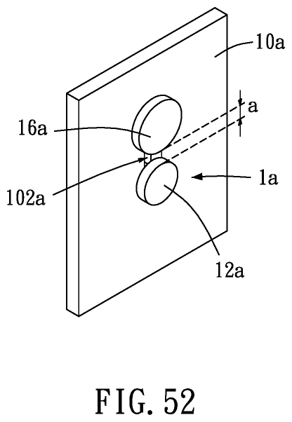

Referring to FIG. 52, as shown, in a preferred specific embodiment of the present disclosure, the blocking portion 12a of the fastener 1a may pass through the elongated hole 101a of the first object 10a, and be receivingly fastened in the receiving fastening portion 102a of the first object 10a by the fastening portion 11a, and then the stopper 16a is installed (or blocked) at the elongated hole 101a, so as to provide a stopping effect at the elongated hole 101a to prevent the fastening portion 11a from departing from the elongated hole 101a. The elongated hole 101a (or the receiving fastening portion 102a) between the blocking portion 12a (or the fastening portion 11a) and the stopper 16a includes a floating space a, which is configured to allow the fastening portion 11a (or the blocking portion 12a) to move therein. Thus, the fastener 1a is enabled to be stably assembled with the first object 10a.

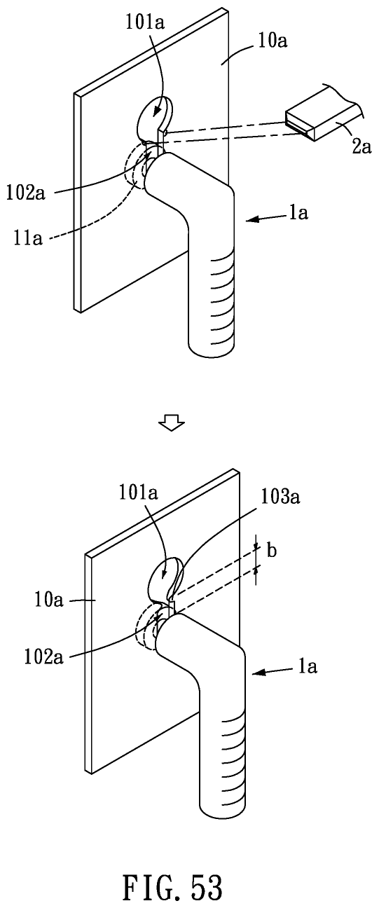

Referring to FIG. 53, as shown, in a preferred specific embodiment of the present disclosure, the fastening portion 11a is first receivingly fastened in the receiving fastening portion 102a, and an external force is applied by a tool 2 on the elongated hole 101a (or the receiving fastening portion 102a), such that a deformed portion 103a is produced at the elongated hole 101a (or the receiving fastening portion 102a), so as to stop the fastening portion 11a at the elongated hole 101a (or the receiving fastening portion 102a) and to prevent the fastening portion 11a from departing from the elongated hole 101a (or the receiving fastening portion 102a).

In a preferred specific embodiment of the present disclosure, between the deformed portion 103a and the fastening portion 11a (or one of the blocking portions 12a) is a floating space b, which is configured to allow the fastening portion 11a (or the blocking portion 12a) to move therein. The floating space b has a dimension between 0.01 mm and 50000 mm, and is a movement track of the fastener 1a. Thus, the present disclosure is enabled to better meet requirements of actual applications.

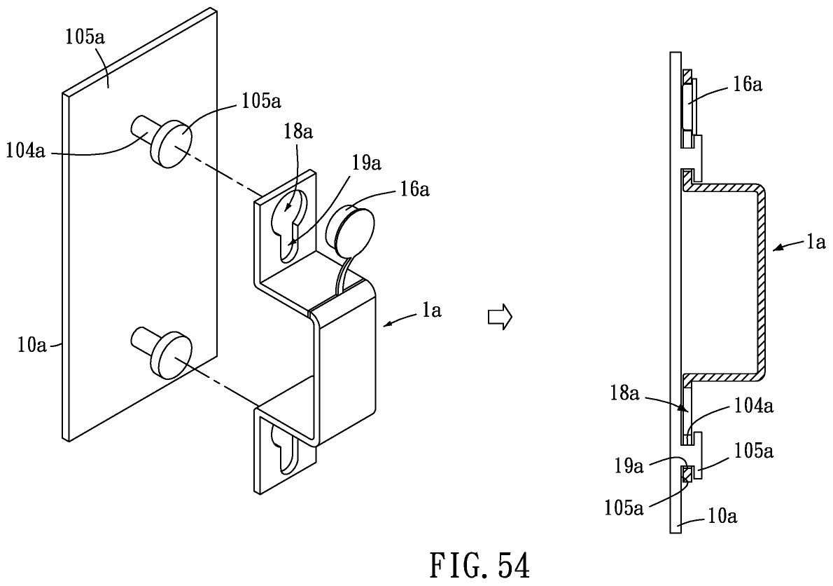

Referring to FIG. 54, as shown, in a preferred specific embodiment of the present disclosure, the fastener 1a includes an elongated hole 18a and a receiving fastening portion 19a, and the first object 10a includes a fastening portion 104a and two blocking portions 105a. For assembly, the fastener 1a passes through one of the blocking portions 105a by the elongated hole 18a, and is then receivingly fastened in the fastening portion 104a by the receiving fastening portion 19a, so as to limit movement of the fastener by the two blocking portions 105a. Thus, the present disclosure is enabled to better meet requirements of actual applications.

In a preferred specific embodiment of the present disclosure, a stopper 16a is further included. The stopper 16a is configured to block horizontal movement of the fastener 1a, such that the fastener 1a is limited at the first object 10a and cannot depart therefrom. Thus, the fastener 1a is enabled to be stably assembled with the first object 10a.

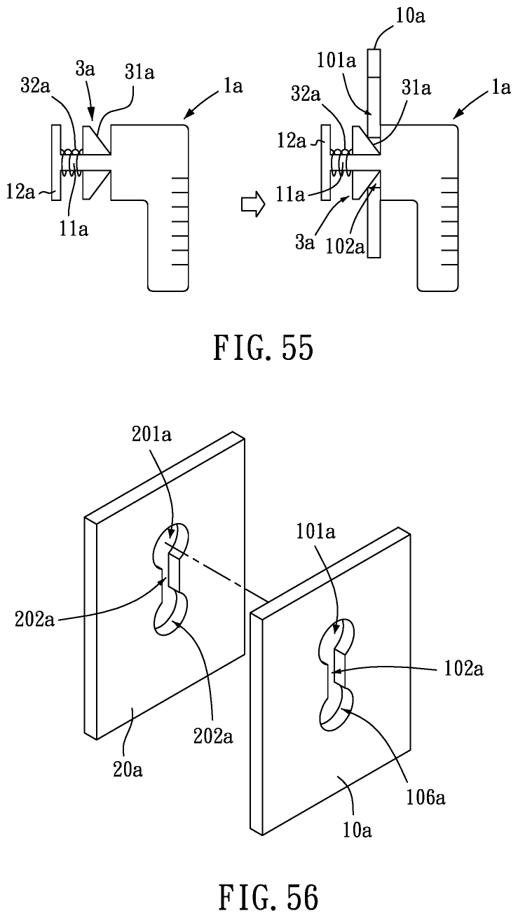

Referring to FIG. 55, as shown, in a preferred specific embodiment of the present disclosure, the fastening portion 11a is surrounded by or assembled with an abutting element 3a, which is configured to block the receiving fastening portion 102a of the first object 10a. Thus, the fastener 1a is enabled to be stably assembled with the first object 10a, so as to prevent the fastening portion from departing from the elongated hole 101a or the receiving fastening portion 102a.

In a preferred specific embodiment of the present disclosure, the abutting element 3a includes a guiding portion 31a, which is configured to guide the abutting element 3a to be fastening connected (or blocked) at the receiving fastening portion 102a. The guiding portion 31a is an inclined surface, an arc surface, a curved surface, a step surface or a planar surface. Thus, the present disclosure is enabled to better meet requirements of actual applications.

In a preferred specific embodiment of the present disclosure, an elastic element 32 is further included. One end of the elastic element 32 is abutted against the abutting element 3a, and the other end is abutted against the blocking portion 12a. Thus, the fastener 1a is enabled to be stably assembled with the first object 10a, so as to prevent the fastening portion 11a from departing from the elongated hole 101a or the receiving fastening portion 102a.

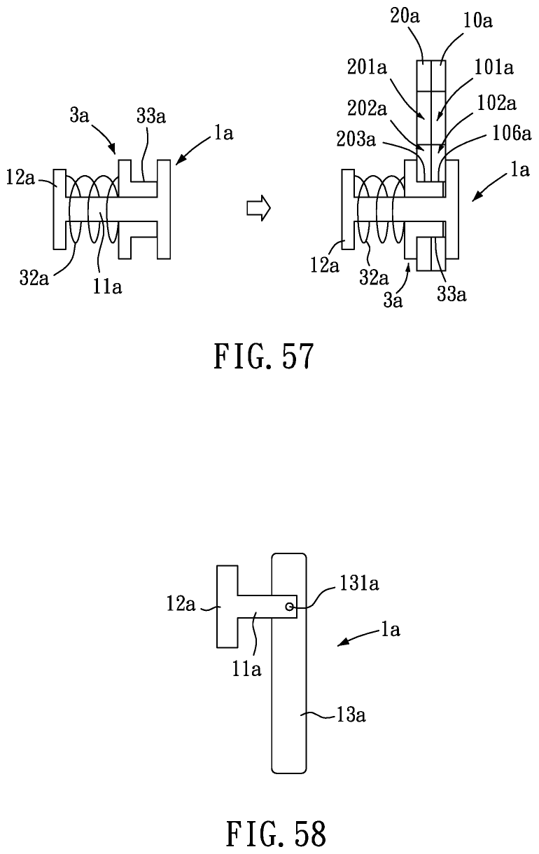

Referring to FIG. 56 and FIG. 57, as shown, in a preferred specific embodiment of the present disclosure, the fastening portion 11a is surrounded by or assembled with an abutting element 3a, which is configured to block fitting fastening portions 106a and 203a of the first object 10a and the second object 20a. Thus, the fastener 1a is enabled to be stably assembled with the first object 10a and the second object 20a.

In a preferred specific embodiment of the present disclosure, the abutting element 3a includes a step portion 33a. The step portion 33a is configured to be receivingly fastened into the fitting fastening portions 106a and 203a of the first object 10a and the second object 20a, so as to fix the abutting element 3a. The width of the step portion 33a is more than (or less than) that of the receiving fastening portions 102a and 202a, and the width of the step portion 33a is less than that of the fitting fastening portions 106a and 203a, so as to fittingly fix the abutting element 3a. Thus, the present disclosure is enabled to better meet requirements of actual applications.

Referring to FIG. 58, as shown, in a preferred specific embodiment of the present disclosure, the body 13a is bolt connected and assembled with the fastening portion 11a by a coupler 131a. Thus, the present disclosure is enabled to better meet requirements of actual applications.

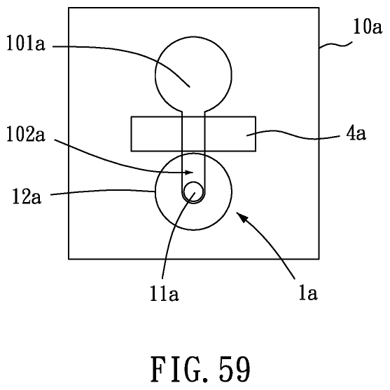

Referring to FIG. 59, as shown, in a preferred specific embodiment of the present disclosure, a stopper 4a is further included. The stopper 4a is configured to stop at the elongated hole 101a or the fastening portion 11a, so as to prevent the fastening portion 11a from departing from the elongated hole 101a or the receiving fastening portion 102a. Thus, the present disclosure is enabled to better meet requirements of actual applications.

While the disclosure has been described by way of example and in terms of the embodiments, a person skilled in the art should understood that the embodiments are for illustrating the present disclosure and are not to be construed as limitations to the scope of the present disclosure. It should be noted that, equivalent modifications and substitutions made to the embodiments are to be encompassed within the scope of the present disclosure. Therefore, the protection scope of the present disclosure is to be accorded with the appended claims.

What is claimed is:

1. A fastener structure, comprising:
a body; and
a fastening portion, provided at the body, the fastening portion comprising a neck, being configured to be receivingly fastened into, assembled into or fitted with a coupling counterpart.

2. The fastener structure of claim 1, wherein the fastening portion is a neck, and the body or the neck comprises a welding surface configured to be welded to a corresponding portion of the coupling counterpart.

3. The fastener structure of claim 2, wherein the body or the fastening portion is configured to be welded by solder to the corresponding portion of the coupling counterpart, and the corresponding portion is a corresponding opening, groove, plane, recess or protrusion.

4. The fastener structure of claim 1, wherein the handle is picked up by a tool and placed at the coupling counterpart so as to be assembled.

5. The fastener structure of claim 1, wherein the handle is picked up by a tool and placed on an assembly position of the coupling counterpart, or the handle is picked up by the tool, compared with the assembly position of the coupling counterpart by a comparison device, and placed on the assembly position of the coupling counterpart.

6. The fastener structure of claim 1, wherein the handle is configured to be placed on a carrier, which comprises or does not comprise a cover.

7. The fastener structure of claim 1, wherein the body includes a base, which is assembled or connected to the fastening portion or the neck.

8. The fastener structure of claim 7, wherein the base is assembled with the body, movably assembled with the body, or assembled with the body by a coupler.

9. The fastener structure of claim 1, wherein the fastening portion is provided on one end of the body, and includes a flat neck configured to be receivingly fastened into, assembled into or fitted with the coupling counterpart.
